(19) United States
(12) Patent Application Publication
(10) Pub. No.: US 2025/0390991 A1
(43) Pub. Date: Dec. 25, 2025

(54) IMAGE PROCESSING METHOD AND APPARATUS

(71) Applicant: Beijing Zitiao Network Technology Co., Ltd., Beijing (CN)

(72) Inventor: Yang BAI, Beijing (CN)

(21) Appl. No.: 19/243,160

(22) Filed: Jun. 19, 2025

(30) Foreign Application Priority Data
Jun. 19, 2024 (CN) 202410793565.3

(51) Int. Cl. G06T 5/70

(52) U.S. Cl. CPC G06T 5/70; G06T 2207/10024

(57) ABSTRACT

Embodiments of the present disclosure provide an image processing method and apparatus and relate to image processing technologies. The method comprises: acquiring a pixel position of a first pixel point in an initial image, the first pixel point being any pixel point in the initial image; performing random offset processing on the pixel position of the first pixel point to acquire an offset position corresponding to the first pixel point; determining an offset pixel point corresponding to the first pixel point according to the offset position corresponding to the first pixel point; performing a blur processing on the offset pixel point corresponding to the first pixel point to obtain a blurred color value corresponding to the first pixel point; assigning the blurred color value corresponding to the first pixel point to a color value of the first pixel point to generate a blurred image corresponding to the initial image.

### CROSS-REFERENCE TO RELATED APPLICATION(S)

This application claims priority to Chinese Application No. 202410793565.3 filed Jun. 19, 2024, the disclosure of which is incorporated herein by reference in its entirety.

### FIELD

The present disclosure relates to the field of image processing technologies, and particularly, to an image processing method and apparatus.

### BACKGROUND

Performing a blur processing on an image refers to performing a specific process on color values of pixels in the image, so that details and edges in the image become blurred, thereby achieving effects such as protecting privacy, presenting artistic creation and reducing noise.

### SUMMARY

Embodiments of the present disclosure provide an image processing method and apparatus.

In order to achieve the object, the embodiments of the present disclosure provide the following technical solutions:

In a first aspect, an embodiment of the present disclosure provides an image processing method, comprising:
acquiring a pixel position of a first pixel point in an initial image, the first pixel point being any pixel point to be blurred in the initial image;
performing random offset processing on the pixel position of the first pixel point to acquire an offset position corresponding to the first pixel point;
determining an offset pixel point corresponding to the first pixel point according to the offset position corresponding to the first pixel point;
performing a blur processing on the offset pixel point corresponding to the first pixel point to acquire a blurred color value corresponding to the first pixel point;
assigning the blurred color value corresponding to the first pixel point to a color value of the first pixel point to generate a blurred image corresponding to the initial image.

As an optional implementation of an embodiment of the present disclosure, the performing random offset processing on the pixel position of the first pixel point to acquire an offset position corresponding to the first pixel point comprises:
generating a first random number and a second random number;
acquiring a second coordinate value according to the first random number and a first coordinate value, the first coordinate value being a horizontal-axis coordinate value of the pixel position of the first pixel point;
acquiring a fourth coordinate value according to the second random number and a third coordinate value, the third coordinate value being a vertical-axis coordinate value of the pixel position of the first pixel point;
acquiring the offset position corresponding to the first pixel point according to the second coordinate value and the fourth coordinate value.

As an optional implementation of an embodiment of the present disclosure, the acquiring a second coordinate value according to the first random number and a first coordinate value comprises: calculating a product of the first random number and a first preset coefficient to acquire a first calculated value; summing the first coordinate value and the first calculated value to acquire the second coordinate value;
the acquiring a fourth coordinate value according to the second random number and a third coordinate value comprises: calculating a product of the second random number and a second preset coefficient to acquire a second calculated value; summing the third coordinate value and the second calculated value to acquire the fourth coordinate value.

As an optional implementation of an embodiment of the present disclosure, the performing a blur processing on the offset pixel point corresponding to the first pixel point to acquire a blurred color value corresponding to the first pixel point comprises:
determining a plurality of sampled points corresponding to the offset pixel point corresponding to the first pixel point based on a preset sampling step size and a preset neighborhood range;
acquiring the blurred color value corresponding to the first pixel point according to the color value of each sampled point and a weight coefficient of each sampled point.

As an optional implementation of an embodiment of the present disclosure, the acquiring a blurred color value corresponding to the first pixel point according to the color value of each sampled point and a weight coefficient of each sampled point comprises:
performing weighted summation on the color values of all sampled points according to weight coefficients of all sampled points to acquire a total color value;
summing the weight coefficients of all sampled points to acquire a total weight coefficient;
calculating a ratio of the total color value to the total weight coefficient to acquire the blurred color value corresponding to the first pixel point.

As an optional implementation of an embodiment of the present disclosure, the determining a plurality of sampled points corresponding to the offset pixel point corresponding to the first pixel point based on a preset sampling step size and a preset neighborhood range comprises:
determining whether a first pixel region is located within the initial image, the first pixel region being a region within a preset neighborhood range of the offset pixel point corresponding to the first pixel point;
if at least one pixel point in the first pixel region is located outside the initial image, assigning a value to the at least one pixel point according to the initial image, and sampling in the first pixel region based on the preset sampling step size to determine the plurality of sampled points.

As an optional implementation of an embodiment of the present disclosure, the determining a plurality of sampled points corresponding to the offset pixel point corresponding to the first pixel point based on a preset sampling step size and a preset neighborhood range comprises:
determining whether a first pixel region is located within the initial image, the first pixel region being a region within a preset neighborhood range of the offset pixel point corresponding to the first pixel point;
if at least one pixel point in the first pixel region is located outside the initial image, determining a second pixel region based on the first pixel region and the initial image, the second pixel region being a region of the first pixel region within the initial image;
sampling in the second pixel region based on the preset sampling step size to determine the plurality of sampled points.

In a second aspect, an embodiment of the present disclosure provides an image processing apparatus, comprising:
an acquisition unit for acquiring a pixel position of a first pixel point in an initial image, the first pixel point being any pixel point to be blurred in the initial image;
an offset unit for performing random offset processing on the pixel position of the first pixel point to acquire an offset position corresponding to the first pixel point;
a determination unit for determining an offset pixel point corresponding to the first pixel point according to the offset position corresponding to the first pixel point;
a processing unit for performing a blur processing on the offset pixel point corresponding to the first pixel point to acquire a blurred color value corresponding to the first pixel point;
a generation unit for assigning the blurred color value corresponding to the first pixel point to a color value of the first pixel point to generate a blurred image corresponding to the initial image.

As an optional implementation of an embodiment of the present disclosure, the offset unit is specifically used for generating a first random number and a second random number; acquiring a second coordinate value according to the first random number and a first coordinate value, the first coordinate value being a horizontal-axis coordinate value of the pixel position of the first pixel point; acquiring a fourth coordinate value according to the second random number and a third coordinate value, the third coordinate value being a vertical-axis coordinate value of the pixel position of the first pixel point; acquiring the offset position corresponding to the first pixel point according to the second coordinate value and the fourth coordinate value.

As an optional implementation of an embodiment of the present disclosure, the offset unit is specifically used for calculating a product of the first random number and a first preset coefficient to acquire a first calculated value; summing the first coordinate value and the first calculated value to acquire the second coordinate value; calculating a product of the second random number and a second preset coefficient to acquire a second calculated value; summing the third coordinate value and the second calculated value to acquire the fourth coordinate value.

As an optional implementation of an embodiment of the present disclosure, the processing unit is specifically used for determining a plurality of sampled points corresponding to the offset pixel point corresponding to the first pixel point based on a preset sampling step size and a preset neighborhood range; acquiring the blurred color value corresponding to the first pixel point according to the color value of each sampled point and a weight coefficient of each sampled point.

As an optional implementation of an embodiment of the present disclosure, the processing unit is specifically used for performing weighted summation on the color values of all sampled points according to weight coefficients of all sampled points to acquire a total color value; summing the weight coefficients of all sampled points to acquire a total weight coefficient; calculating a ratio of the total color value to the total weight coefficient to acquire the blurred color value corresponding to the first pixel point.

As an optional implementation of an embodiment of the present disclosure, the processing unit is specifically used for determining whether a first pixel region is located within the initial image, the first pixel region being a region within a preset neighborhood range of the offset pixel point corresponding to the first pixel point; if at least one pixel point in the first pixel region is located outside the initial image, assigning a value to the at least one pixel point according to the initial image, and sampling in the first pixel region based on the preset sampling step size to determine the plurality of sampled points.

As an optional implementation of an embodiment of the present disclosure, the processing unit is specifically used for determining whether a first pixel region is located within the initial image, the first pixel region being a region within a preset neighborhood range of the offset pixel point corresponding to the first pixel point; if at least one pixel point in the first pixel region is located outside the initial image, determining a second pixel region based on the first pixel region and the initial image, the second pixel region being a region of the first pixel region within the initial image; sampling in the second pixel region based on the preset sampling step size to determine the plurality of sampled points.

In a third aspect, an embodiment of the present disclosure provides an electronic device, comprising: a memory and a processor, the memory being used for storing a computer program, and the processor being used for causing the electronic device to implement the image processing method according to any of the above implementations upon executing the computer program.

In a fourth aspect, an embodiment of the present disclosure provides a computer-readable storage medium having stored thereon a computer program which, when executed by a computing device, causes the computing device to implement the image processing method according to any of the above implementations.

In a fifth aspect, an embodiment of the present disclosure provides a computer program product which, when run on a computer, causes the computer to implement the image processing method according to any of the above implementations.

### BRIEF DESCRIPTION OF THE DRAWINGS

The drawings here, which are incorporated in and constitute a part of the description, illustrate embodiments complying with the present disclosure and, together with the description, serve to illustrate the principles of the present disclosure.

In order to illustrate technical solutions in embodiments of the present disclosure or the prior art more clearly, figures to be used in the depictions of the embodiments or prior art will be introduced briefly below; it be obvious for those skilled in the art to acquire other figures according to these figures without making any inventive efforts.

FIG. 1 illustrates a flow chart showing steps of an image processing method according to an embodiment of the present disclosure;

FIG. 2 illustrates a flow chart showing steps of another image processing method according to an embodiment of the present disclosure;

FIG. 3 illustrates a first schematic diagram about assigning a value to a pixel point according to an embodiment of the present disclosure;

FIG. 4 illustrates a second schematic diagram about assigning a value to a pixel point according to an embodiment of the present disclosure;

FIG. 5 illustrates a schematic diagram of a second pixel region according to an embodiment of the present disclosure;

FIG. 6 illustrates a schematic diagram of an image processing apparatus according to an embodiment of the present disclosure;

FIG. 7 illustrates a schematic diagram showing hardware of an electronic device according to an embodiment of the present disclosure.

### DETAILED DESCRIPTION OF EMBODIMENTS

Solutions of the present disclosure will be further described to enable clearer understanding of the above objectives, features and advantages of the present disclosure. It needs to be appreciated that embodiments of the present disclosure and features in the embodiments may be combined with one another in the absence of conflicts.

At present, a blur algorithm is usually sampling in a certain neighborhood range of pixel points based on a preset sampling step size, then solving weight coefficients of the sampled points with a certain relational expression, and finally performing a weighted calculation according to the color values of all sampled points and corresponding weight coefficients to acquire color values of the pixel points after the blur processing. When the blur processing is performed on the image, the larger the sampling step size is, the smaller the number of sampled points is, and the smaller the computational amount of the blur processing is. On the contrary, the smaller the sampling step size is, the larger the number of sampled points is, and the larger the computational amount of the blur processing is. In many scenes, the sampling step size is set larger when the blur processing is performed on the image in order to reduce the computational amount of the blur processing. However, setting the sampling step size larger is liable to cause the failure of smooth transition between pixel points of the blurred image due to the insufficient number of sampled points, thereby causing the occurrence of a lattice effect or a layering effect in the blurred image.

In the following description, a lot of specific details are illustrated to provide a thorough understanding of the present disclosure. However, the present disclosure may be also implemented otherwise than as specifically described herein. The embodiments in the description are only part of embodiments of the present disclosure other than all embodiments.

In the embodiments of the present disclosure, the words “exemplary” or “for example” are used to mean serving as an example, instance, or illustration. Any embodiment or design solution described herein as “exemplary” or “for example” should not be construed as being preferable or advantageous over other embodiments or designs. Rather, invoking the words such as “exemplary” or “such as” is intended to present relevant concepts in a specific manner. Further, in the depictions of the embodiments of the present disclosure, “a plurality” means two or more unless otherwise specified.

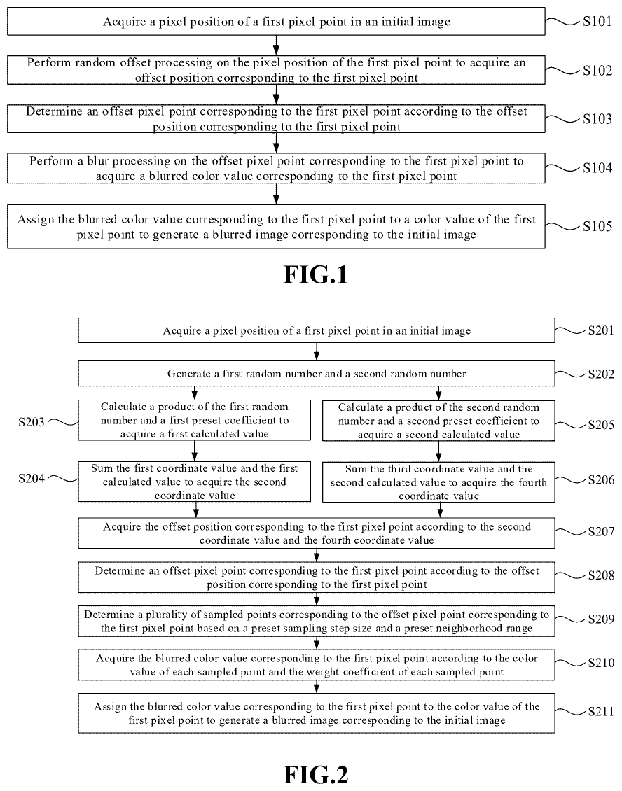

An embodiment of the present disclosure provides an image processing method. Referring to FIG. 1, the image processing method comprises the following steps:

S101: acquiring a pixel position of a first pixel point in an initial image.

Wherein the first pixel point is any pixel point to be blurred in the initial image.

The initial image in the embodiment of the present disclosure refers to an image to be blurred, and the initial image may be any type of image.

In some embodiments, before acquiring the pixel position of the first pixel point in the initial image, it is possible to first determine all the pixel points to be blurred in the initial image to acquire a set of pixel points to be blurred, then traverse the pixel points in the set of pixel points to be blurred, and perform the image processing method according to the embodiment of the present disclosure using the current pixel point as the first pixel point.

S102: performing random offset processing on the pixel position of the first pixel point to acquire an offset position corresponding to the first pixel point.

That is, an offset value is added to the pixel position of the first pixel point to acquire another pixel position, and the newly-acquired pixel position is determined as the pixel position of the first pixel point.

In some embodiments, the pixel position of the first pixel point comprises: a horizontal-axis coordinate value and a vertical-axis coordinate value. The above step S102 (performing random offset processing on the pixel position of the first pixel point to acquire an offset position corresponding to the first pixel point) comprises the following Step a through Step d:

Step a: generating a first random number and a second random number.

That is, two random numbers are generated and defined as the first random number and the second random number, respectively.

Step b: acquiring a second coordinate value according to the first random number and

a first coordinate value.

The first coordinate value is a horizontal-axis coordinate value of the pixel position of the first pixel point.

In some embodiments, the acquiring a second coordinate value according to the first random number and a first coordinate value comprises:

summing the first random number and the first coordinate value to acquire the second coordinate value.

That is, if the first random number is represented as p, the first coordinate value is represented as x₁, and the second coordinate value is represented as x₂, then

$${x}_{2} = {x}_{1} + p$$

Step c: acquiring a fourth coordinate value according to the second random number and a third coordinate value.

Wherein the third coordinate value is a vertical-axis coordinate value of the pixel position of the first pixel point.

In some embodiments, the acquiring a fourth coordinate value according to the second random number and a third coordinate value comprises:

summing the second random number and the third coordinate value to acquire the fourth coordinate value.

In other words, let the second random number be represented by q, the third coordinate value be represented by y₁, and the fourth coordinate value be represented by y₂, then

$${y}_{2} = {y}_{1} + q$$

Step d: acquiring an offset position corresponding to the first pixel point according to the second coordinate value and the fourth coordinate value.

As described in the above example, the second coordinate value is x₂, and the fourth coordinate value is y₂, and therefore the coordinate values of the offset position corresponding to the first pixel point are (x₂, y₂).

S103: determining an offset pixel point corresponding to the first pixel point according to the offset position corresponding to the first pixel point.

In some embodiments, the determining an offset pixel point corresponding to the first pixel point according to the offset position corresponding to the first pixel point comprises: determining a pixel point whose center is closest to the offset position corresponding to the first pixel point, as the offset pixel point corresponding to the first pixel point.

That is, distances from the centers of pixel points around the offset position corresponding to the first pixel point to the offset position corresponding to the first pixel point are calculated, and the pixel point with a minimum distance is determined as the offset pixel point corresponding to the first pixel point.

S104: performing a blur processing on the offset pixel point corresponding to the first pixel point to acquire a blurred color value corresponding to the first pixel point.

The embodiment of the present disclosure does not limit a blur processing algorithm used when performing the blur processing on the offset pixel point corresponding to the first pixel point. Exemplarily, the blur processing algorithm may be: mean blur, Gaussian blur, median blur, bilateral filtering, guided filtering, etc.

S105: assigning the blurred color value corresponding to the first pixel point to a color value of the first pixel point to generate a blurred image corresponding to the initial image.

That is, the above step S101 through step S104 are respectively performed on each pixel point to be blurred of the initial image to acquire the blurred color value corresponding to each pixel point to be blurred of the initial image, and then the color value of each pixel point to be blurred of the initial image is replaced with the corresponding blurred color value to acquire a blurred image corresponding to the initial image.

According to the image processing method according to the embodiment of the present disclosure, after the pixel position of the first pixel point to be blurred in the initial image is acquired, random offset processing is first performed on the pixel position of the first pixel point to acquire the offset position corresponding to the first pixel point, then the offset pixel point corresponding to the first pixel point is determined according to the offset position corresponding to the first pixel point, and the blur processing is performed on the offset pixel point corresponding to the first pixel point to acquire the blurred color value corresponding to the first pixel point, and finally, the blurred color value corresponding to the first pixel point is assigned to the color value of the first pixel point to generate the blurred image corresponding to the initial image. According to the embodiment of the present disclosure, the blur processing is performed on the offset pixel point corresponding to the pixel point to be blurred to acquire the blurred color value corresponding to the first pixel point, and the blurred color value corresponding to the first pixel point is assigned to the color value of the first pixel point. Therefore, the embodiment of the present disclosure may break the regularized arrangement of the original lattice effect or layering effect to thereby reduce or avoid the occurrence of the lattice effect or the layering effect in the blurred image without increasing the number of sampled points. In other words, the embodiments of the present disclosure are used for reducing or avoiding the occurrence of the lattice effect or layering effect in the blurred image without increasing the number of sampled points.

As an extension and refinement to the above embodiment, another embodiment of the present disclosure provides an image processing method. As shown in FIG. 2, the image processing method comprises the following steps:

S201: acquiring a pixel position of a first pixel point in an initial image.

The first pixel point is any pixel point to be blurred in the initial image.

S202: generating a first random number and a second random number.

In some embodiments, the first random number and the second random number may be generated by a pseudo-random number generator.

S203: calculating a product of the first random number and a first preset coefficient to acquire a first calculated value.

If the first random number is represented as p, the first preset coefficient is represented as a, and the first calculated value is represented as m, then

$$m = p * a$$

S204: summing the first coordinate value and the first calculated value to acquire the second coordinate value.

The first coordinate value is a horizontal-axis coordinate value of the pixel position of the first pixel point.

If the first coordinate value is represented as x₁, and the second coordinate value is represented as x₂, then:

$${x}_{2} = {x}_{1} + m = {x}_{1} + p * a$$

S205: calculating a product of the second random number and a second preset coefficient to acquire a second calculated value.

The second coordinate value is a vertical-axis coordinate value of the pixel position of the first pixel point.

If the second random number is represented as q, the second preset coefficient is represented as b, and the second calculated value is represented as n, then:

$$n = q * b$$

In some embodiments, the first preset coefficient is equal to the second preset coefficient.

S206: summing the third coordinate value and the second calculated value to acquire the fourth coordinate value.

If the third coordinate value is represented as y₁, and the second coordinate value is represented as y₂, then:

$${y}_{2} = {y}_{1} + n = {y}_{1} + q * b$$

S207: acquiring the offset position corresponding to the first pixel point according to the second coordinate value and the fourth coordinate value.

S208: determining an offset pixel point corresponding to the first pixel point according to the offset position corresponding to the first pixel point.

S209: determining a plurality of sampled points corresponding to the offset pixel point corresponding to the first pixel point based on a preset sampling step size and a preset neighborhood range.

In some embodiments, the above step S209 (determining a plurality of sampled points corresponding to the offset pixel point corresponding to the first pixel point based on a preset sampling step size and a preset neighborhood range) comprises the following Step 1 through Step 4:

Step 1: determining whether a first pixel region is located within the initial image.

The first pixel region is a region within a preset neighborhood range of the offset pixel point corresponding to the first pixel point.

In the above Step 1, if each pixel point in the first pixel region is located in the initial image, the following Step 2 will be performed:

Step 2: sampling in the first pixel region based on the preset sampling step size to determine the plurality of sampled points.

In the above Step 1, if at least one pixel point in the first pixel region is located outside the initial image, the following Step 3 and Step 4 are performed:

Step 3: assigning a value to the at least one pixel point according to the initial image.

In some embodiments, the assigning a value to the at least one pixel point according to the initial image comprises: respectively acquiring a symmetric pixel point corresponding to the at least one pixel point, and assigning a color value of the corresponding symmetric pixel point to the color value of each pixel point. A symmetrical pixel point corresponding to any one pixel point is a pixel point symmetrical to the pixel point about a boundary of the initial image as an axis of symmetry.

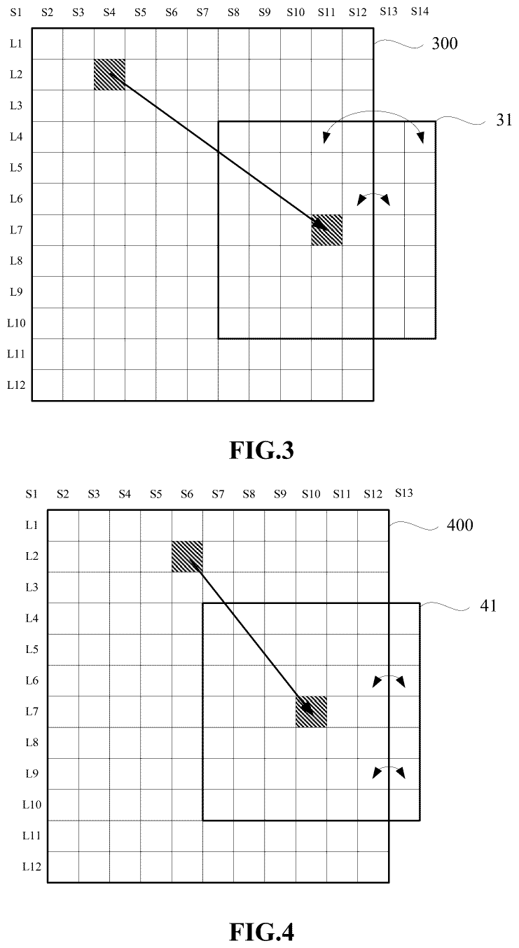

By way of example, with reference to FIG. 3, FIG. 3 exemplarily shows that a resolution of the initial image is 12*12, and the preset neighborhood range is the size of 4 pixel points. The pixel coordinates of the first pixel point are (2, 4), the pixel coordinates of the offset pixel point corresponding to the first pixel point are (7, 11), and a plurality of pixel points of a first pixel region 31 within the preset neighborhood range of the offset pixel point corresponding to the first pixel point are located outside an initial image 300, and therefore the color value of the corresponding symmetrical pixel point is assigned to the color value of each pixel point located outside the initial image 300. For example, the color value of the pixel point with pixel coordinate (4, 11) is assigned to the color value of the pixel point with pixel coordinate (4, 14). As another example, the color value of the pixel point with pixel coordinate (6, 12) is assigned to the color value of the pixel point with pixel coordinate (6, 13).

In some embodiments, the assigning a value to the at least one pixel point according to the initial image comprises: acquiring the nearest pixel point corresponding to the at least one pixel point, respectively, and assigning a color value of the corresponding nearest pixel point is assigned to the color value of each pixel point. The nearest pixel point corresponding to any pixel point is a pixel point with a minimum distance from the pixel point among the pixel points of the initial image.

Exemplarily, with reference to FIG. 4, FIG. 4 exemplarily shows that the resolution of the initial image is 12*12, and the preset neighborhood range is the size of 4 pixel points. The pixel coordinates of the first pixel point are (2, 4), the pixel coordinates of the offset pixel point corresponding to the first pixel point are (7, 11), and a plurality of pixel points of a first pixel region 41 within a preset neighborhood range of the offset pixel point corresponding to the first pixel point are located outside the initial image 400, and therefore the color value of the corresponding nearest pixel point is assigned to the color value of each pixel point located outside the initial image 400. For example, the color value of the pixel point with pixel coordinates (6, 12) is assigned to the color value of the pixel point with pixel coordinates (6, 13). As an example, the color value of the pixel point with pixel coordinates (9, 12) is assigned to the color value of the pixel point with pixel coordinates (9, 13).

In some embodiments, the assigning a value to the at least one pixel point according to the initial image comprises: determining a preset value according to the initial image, and assigning the preset value to the color value of the at least one pixel point.

In some embodiments, the preset value may be an average value of color values of the pixel points of the initial image.

In some embodiments, the preset value may be zero.

Step 4: sampling in the first pixel region based on the preset sampling step size to determine the plurality of sampled points.

In some embodiments, the above Step S209 (determining a plurality of sampled points corresponding to the offset pixel point corresponding to the first pixel point based on a preset sampling step size and a preset neighborhood range) comprises the following Step \textcircled{1} though Step \textcircled{4}:

Step \textcircled{1}: determining whether a first pixel region is located within the initial image.

The first pixel region is a region within a preset neighborhood range of the offset pixel point corresponding to the first pixel point.

In the above step \textcircled{1}, if each pixel point in the first pixel region is located in the initial image, the following Step \textcircled{2} is performed:

Step \textcircled{2}): sampling in the first pixel region based on the preset sampling step size to determine the plurality of sampled points.

In the above step \textcircled{1}, if at least one pixel point in the first pixel region is located outside the initial image, the following Step \textcircled{3} and Step \textcircled{4} are performed:

Step \textcircled{3}: determining a second pixel region based on the first pixel region and the initial image.

The second pixel region is a region of the first pixel region within the initial image.

Step \textcircled{4}: sampling in the second pixel region based on the preset sampling step size to determine the plurality of sampled points.

By way of example, with reference to FIG. 5, FIG. 5 exemplarily shows the resolution of the initial image is 12*12, and the preset neighborhood range is the size of 4 pixel points. The pixel coordinates of the first pixel point is (4, 5), the pixel coordinates of the offset pixel point corresponding to the first pixel point are (10, 10), and a plurality of pixel points of a first pixel region 51 in a preset neighborhood range of the offset pixel point corresponding to the first pixel point are located outside an initial image 400; therefore, a second pixel region 52 is determined based on the first pixel region 51 and the initial image 500, and sampling is performed in the second pixel region based on the preset sampling step size to determine the plurality of sampled points.

S210: acquiring the blurred color value corresponding to the first pixel point according to the color value of each sampled point and the weight coefficient of each sampled point.

In some embodiments, the above Step S210 (acquiring the blurred color value corresponding to the first pixel point according to the color value of each sampled point and the weight coefficient of each sampled point) comprises: performing weighted summation on the color values of all sampled points according to weight coefficients of all sampled points to acquire a total color value; summing weight coefficients of all sampled points to acquire a total weight coefficient; calculating a ratio of the total color value to the total weight coefficient to acquire the blurred color value corresponding to the first pixel point.

In other words, if the blurred color value corresponding to the pixel point is represented as I_{blur}, the color value of the i^{th} sampled point is represented as Iᵢ, and the weight coefficient of the i^{th} sampled point is represented as wᵢ, then:

$${I}_{blur} = {\sum }_{i = 1}^{N} {I}_{i} * {w}_{i} / {\sum }_{i = 1}^{N} {w}_{i}$$

where N is the total number of sampled points.

That is, weighted average summation is performed on the color values of all sampled points according to the weight coefficients of all sampled points, to acquire the blurred color value corresponding to the first pixel point.

S211: assigning the blurred color value corresponding to the first pixel point is assigned to the color value of the first pixel point to generate a blurred image corresponding to the initial image.

Based on the same inventive concept, an embodiment of the present disclosure further provides an image processing apparatus as an implementation of the above method, and the present embodiment corresponds to the above method embodiment; for ease of reading, this embodiment will not repeat the details of the above method embodiment one by one, but it should be appreciated that the image processing apparatus in the present embodiment may correspondingly implement all the content of the above method embodiment.

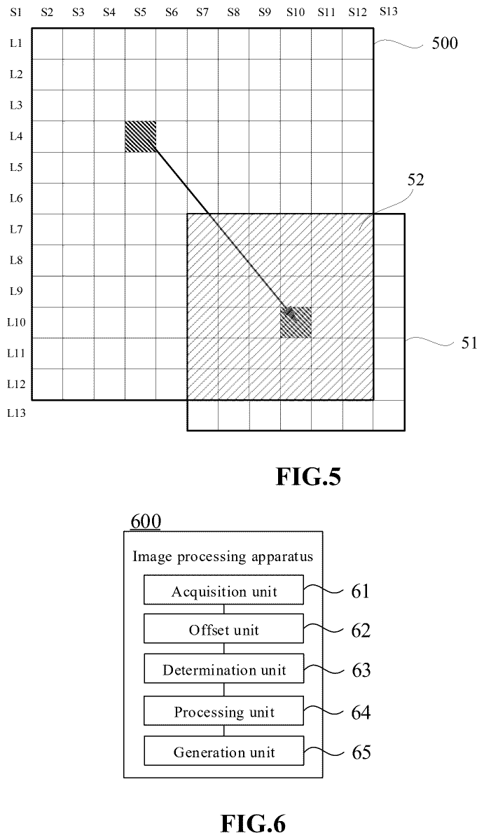

An embodiment of the present disclosure provides an image processing apparatus. FIG. 6 illustrates a schematic diagram of an image processing apparatus. As shown in FIG. 6, the image processing apparatus 600 comprises:
an acquisition unit 61 for acquiring a pixel position of a first pixel point in an initial image, the first pixel point being any pixel point to be blurred in the initial image;
an offset unit 62 for performing random offset processing on the pixel position of the first pixel point to acquire an offset position corresponding to the first pixel point;
a determination unit 63 for determining an offset pixel point corresponding to the first pixel point according to the offset position corresponding to the first pixel point;
a processing unit 64 for performing a blur processing on the offset pixel point corresponding to the first pixel point to acquire a blurred color value corresponding to the first pixel point;
a generation unit 65 for assigning the blurred color value corresponding to the first pixel point to the color value of the first pixel point to generate a blurred image corresponding to the initial image.

As an optional implementation of an embodiment of the present disclosure, the offset unit 62 is specifically used for generating a first random number and a second random number; acquiring a second coordinate value according to the first random number and a first coordinate value, the first coordinate value being a horizontal-axis coordinate value of the pixel position of the first pixel point; acquiring a fourth coordinate value according to the second random number and a third coordinate value, the third coordinate value being a vertical-axis coordinate value of the pixel position of the first pixel point; acquiring the offset position corresponding to the first pixel point according to the second coordinate value and the fourth coordinate value.

As an optional implementation of an embodiment of the present disclosure, the offset unit 62 is specifically used for calculating a product of the first random number and a first preset coefficient to acquire a first calculated value; summing the first coordinate value and the first calculated value to acquire the second coordinate value; calculating a product of the second random number and a second preset coefficient to acquire a second calculated value; summing the third coordinate value and the second calculated value to acquire the fourth coordinate value.

As an optional implementation of an embodiment of the present disclosure, the processing unit 64 is specifically used for determining a plurality of sampled points corresponding to the offset pixel point corresponding to the first pixel point based on a preset sampling step size and a preset neighborhood range; acquiring the blurred color value corresponding to the first pixel point according to the color value of each sampled point and the weight coefficient of each sampled point.

As an optional implementation of an embodiment of the present disclosure, the processing unit 64 is specifically used for performing weighted summation on the color values of all sampled points according to weight coefficients of all sampled points to acquire a total color value; summing weight coefficients of all sampled points to acquire a total weight coefficient; calculating a ratio of the total color value to the total weight coefficient to acquire the blurred color value corresponding to the first pixel point.

As an optional implementation of an embodiment of the present disclosure, the processing unit 64 is specifically used for determining whether a first pixel region is located within the initial image, the first pixel region being a region within a preset neighborhood range of the offset pixel point corresponding to the first pixel point; if at least one pixel point in the first pixel region is located outside the initial image, assigning a value to the at least one pixel point according to the initial image, and sampling in the first pixel region based on the preset sampling step size to determine the plurality of sampled points.

As an optional implementation of an embodiment of the present disclosure, the processing unit 64 is specifically used for determining whether a first pixel region is located within the initial image, the first pixel region being a region within a preset neighborhood range of the offset pixel point corresponding to the first pixel point; if at least one pixel point in the first pixel region is located outside the initial image, determining a second pixel region based on the first pixel region and the initial image, the second pixel region being a region of the first pixel region within the initial image; sampling in the second pixel region based on the preset sampling step size to determine the plurality of sampled points.

The image processing apparatus according to the embodiment of the present disclosure may perform the image processing method according to any of the above embodiments, and the implementation principles and resultant technical effects of the image processing apparatus are similar to those of the image processing method, and will not be described in detail any more herein.

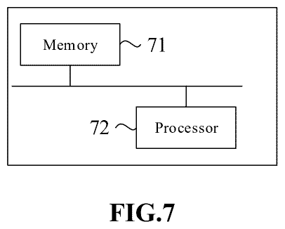

Based on the same inventive concept, an embodiment of the present disclosure further provides an electronic device. FIG. 7 illustrates a schematic diagram of an electronic device according to an embodiment of the present disclosure. As shown in FIG. 7, the electronic device according to the present embodiment comprises: a memory 701 and a processor 702, the memory 701 being used for storing a computer program, and the processor 702 being used for performing the image processing method according to the above embodiments upon executing the computer program.

Based on the same inventive concept, an embodiment of the present disclosure further provides a computer-readable storage medium having stored thereon a computer program which, when executed by a processor, causes the computing device to implement the image processing method according to the above embodiments.

Based on the same inventive concept, an embodiment of the present disclosure further provides a computer program product which, when run on a computer, causes the computer to implement the image processing method according to the above embodiments.

As will be appreciated by those skilled in the art, embodiments of the present disclosure may be provided as a method, system, or computer program product. Accordingly, the present disclosure may take the form of an entirely hardware embodiment, an entirely software embodiment or an embodiment combining software and hardware aspects. Moreover, the present disclosure may take the form of a computer program product embodied in one or more computer-usable storage media having computer-usable program code embodied therein.

The processor may be a Central Processing Unit (CPU), and may also be other general-purpose processors, a Digital Signal Processor (DSP), an Application Specific Integrated Circuit (ASIC), a Field-Programmable Gate Array (FPGA) or other programmable logic device, a discrete gate or transistor logic device, discrete hardware components, etc. The general-purpose processor may be a microprocessor, or the processor may also be any conventional processor.

The memory may include forms such as non-persistent memory, Random Access Memory (RAM), and/or non-volatile memory such as Read Only Memory (ROM) or flash memory (flashRAM) in the computer readable medium. The memory is an example of the computer-readable medium.

The computer-readable medium comprises permanent and non-permanent, removable and non-removable storage medium. The storage medium may implement the storage of information by any method or technology, and the information may be computer-readable instructions, data structures, modules of a program, or other data. Examples of the storage medium for a computer includes, but not limited to, Phase Change Random Access Memory (PRAM), Static Random Access Memory (SRAM), Dynamic Random Access Memory (DRAM), other types of random access memory (RAM), Read Only Memory (ROM), Electrically Erasable Programmable Read Only Memory (EEPROM), flash memory or other memory technology, Compact Disk Read Only Memory (CD-ROM), Digital Versatile Disks (DVD) or other optical storage, magnetic cassette-type magnetic tapes, magnetic disk storage or other magnetic storage devices, or any other non-transmission media, and may be used to store information accessible by the computing device. As defined herein, the computer-readable medium does not include transitory media, such as modulated data signals and carriers.

Finally, it should be appreciated that the above embodiments are only intended to illustrate the technical solutions of the present disclosure, not to limit them. Although the present disclosure has been described in detail with reference to the above embodiments, those skilled in the art should appreciate that they can still make modifications to the technical solutions disclosed in the above embodiments, or make equivalent substitutions for some or all of the technical features thereof. These modifications or substitutions do not make the essence of corresponding technical solutions depart from the scope of the technical solutions of the embodiments of the present disclosure.

I/We claim:

1. An image processing method, comprising:
acquiring a pixel position of a first pixel point in an initial image, the first pixel point being any pixel point to be blurred in the initial image;
performing random offset processing on the pixel position of the first pixel point to acquire an offset position corresponding to the first pixel point;
determining an offset pixel point corresponding to the first pixel point according to the offset position corresponding to the first pixel point;
performing a blur processing on the offset pixel point corresponding to the first pixel point to acquire a blurred color value corresponding to the first pixel point; and
assigning the blurred color value corresponding to the first pixel point to a color value of the first pixel point to generate a blurred image corresponding to the initial image.

2. The method according to claim 1, wherein performing random offset processing on the pixel position of the first pixel point to acquire an offset position corresponding to the first pixel point comprises:
generating a first random number and a second random number;
acquiring a second coordinate value according to the first random number and a first coordinate value, the first coordinate value being a horizontal-axis coordinate value of the pixel position of the first pixel point;
acquiring a fourth coordinate value according to the second random number and a third coordinate value, the third coordinate value being a vertical-axis coordinate value of the pixel position of the first pixel point; and
acquiring the offset position corresponding to the first pixel point according to the second coordinate value and the fourth coordinate value.

3. The method according to claim 2, wherein,
acquiring a second coordinate value according to the first random number and a first coordinate value comprises: calculating a product of the first random number and a first preset coefficient to acquire a first calculated value, and summing the first coordinate value and the first calculated value to acquire the second coordinate value; and
acquiring a fourth coordinate value according to the second random number and a third coordinate value comprises: calculating a product of the second random number and a second preset coefficient to acquire a second calculated value, and summing the third coordinate value and the second calculated value to acquire the fourth coordinate value.

4. The method according to claim 1, wherein performing a blur processing on the offset pixel point corresponding to the first pixel point to acquire a blurred color value corresponding to the first pixel point comprises:
determining a plurality of sampled points corresponding to the offset pixel point corresponding to the first pixel point based on a preset sampling step size and a preset neighborhood range; and
acquiring the blurred color value corresponding to the first pixel point according to a color value of each sampled point and a weight coefficient of each sampled point.

5. The method according to claim 4, wherein acquiring the blurred color value corresponding to the first pixel point according to a color value of each sampled point and a weight coefficient of each sampled point comprises:
performing weighted summation on the color values of all sampled points according to weight coefficients of all sampled points to acquire a total color value;
summing the weight coefficients of all sampled points to acquire a total weight coefficient; and
calculating a ratio of the total color value to the total weight coefficient to acquire the blurred color value corresponding to the first pixel point.

6. The method according to claim 4, wherein determining a plurality of sampled points corresponding to the offset pixel point corresponding to the first pixel point based on a preset sampling step size and a preset neighborhood range comprises:
determining whether a first pixel region is located within the initial image, the first pixel region being a region within a preset neighborhood range of the offset pixel point corresponding to the first pixel point; and
in response to at least one pixel point in the first pixel region being located outside the initial image, assigning a value to the at least one pixel point according to the initial image, and sampling within the first pixel region based on the preset sampling step size to determine the plurality of sampled points.

7. The method according to claim 4, wherein determining a plurality of sampled points corresponding to the offset pixel point corresponding to the first pixel point based on a preset sampling step size and a preset neighborhood range comprises:
determining whether a first pixel region is located within the initial image, the first pixel region being a region within a preset neighborhood range of the offset pixel point corresponding to the first pixel point;
in response to at least one pixel point in the first pixel region being located outside the initial image, determining a second pixel region based on the first pixel region and the initial image, the second pixel region being a region of the first pixel region located within the initial image; and
sampling within the second pixel region based on the preset sampling step size to determine the plurality of sampled points.

8. An electronic device, comprising:
one or more processors;
a storage device for storing one or more programs, wherein,
the one or more programs, when executed by the one or more processors, cause the one or more processors to:
acquire a pixel position of a first pixel point in an initial image, the first pixel point being any pixel point to be blurred in the initial image;
perform random offset processing on the pixel position of the first pixel point to acquire an offset position corresponding to the first pixel point;
determine an offset pixel point corresponding to the first pixel point according to the offset position corresponding to the first pixel point;
perform a blur processing on the offset pixel point corresponding to the first pixel point to acquire a blurred color value corresponding to the first pixel point; and
assign the blurred color value corresponding to the first pixel point to a color value of the first pixel point to generate a blurred image corresponding to the initial image.

9. The device according to claim 8, wherein the one or more programs causing the one or more processors to perform random offset processing on the pixel position of the first pixel point to acquire an offset position corresponding to the first pixel point comprise instructions to:
generate a first random number and a second random number;
acquire a second coordinate value according to the first random number and a first coordinate value, the first coordinate value being a horizontal-axis coordinate value of the pixel position of the first pixel point;
acquire a fourth coordinate value according to the second random number and a third coordinate value, the third coordinate value being a vertical-axis coordinate value of the pixel position of the first pixel point; and
acquire the offset position corresponding to the first pixel point according to the second coordinate value and the fourth coordinate value.

10. The device according to claim 9, wherein,
the one or more programs causing the one or more processors to acquire a second coordinate value according to the first random number and a first coordinate value comprise instructions to: calculate a product of the first random number and a first preset coefficient to acquire a first calculated value, and sum the first coordinate value and the first calculated value to acquire the second coordinate value; and
the one or more programs causing the one or more processors to acquiring a fourth coordinate value according to the second random number and a third coordinate value comprise instructions to: calculate a product of the second random number and a second preset coefficient to acquire a second calculated value, and sum the third coordinate value and the second calculated value to acquire the fourth coordinate value.

11. The device according to claim 8, wherein the one or more programs causing the one or more processors to perform a blur processing on the offset pixel point corresponding to the first pixel point to acquire a blurred color value corresponding to the first pixel point comprise instructions to:
determine a plurality of sampled points corresponding to the offset pixel point corresponding to the first pixel point based on a preset sampling step size and a preset neighborhood range; and
acquire the blurred color value corresponding to the first pixel point according to a color value of each sampled point and a weight coefficient of each sampled point.

12. The device according to claim 11, wherein the one or more programs causing the one or more processors to acquire the blurred color value corresponding to the first pixel point according to a color value of each sampled point and a weight coefficient of each sampled point comprise instructions to:
perform weighted summation on the color values of all sampled points according to weight coefficients of all sampled points to acquire a total color value;
sum the weight coefficients of all sampled points to acquire a total weight coefficient; and
calculate a ratio of the total color value to the total weight coefficient to acquire the blurred color value corresponding to the first pixel point.

13. The device according to claim 11, wherein the one or more programs causing the one or more processors to determine a plurality of sampled points corresponding to the offset pixel point corresponding to the first pixel point based on a preset sampling step size and a preset neighborhood range comprise instructions to:
determine whether a first pixel region is located within the initial image, the first pixel region being a region within a preset neighborhood range of the offset pixel point corresponding to the first pixel point; and
in response to at least one pixel point in the first pixel region being located outside the initial image, assign a value to the at least one pixel point according to the initial image, and sample within the first pixel region based on the preset sampling step size to determine the plurality of sampled points.

14. The device according to claim 11, wherein the one or more programs causing the one or more processors to determine a plurality of sampled points corresponding to the offset pixel point corresponding to the first pixel point based on a preset sampling step size and a preset neighborhood range comprise instructions to:
determine whether a first pixel region is located within the initial image, the first pixel region being a region within a preset neighborhood range of the offset pixel point corresponding to the first pixel point;
in response to at least one pixel point in the first pixel region being located outside the initial image, determine a second pixel region based on the first pixel region and the initial image, the second pixel region being a region of the first pixel region located within the initial image; and
sample within the second pixel region based on the preset sampling step size to determine the plurality of sampled points.

15. A non-transitory storage medium containing computer-executable instructions, wherein the computer-executable instructions, when executed by one or more computer processors, are used to cause the one or more computer processors to:
acquire a pixel position of a first pixel point in an initial image, the first pixel point being any pixel point to be blurred in the initial image;
perform random offset processing on the pixel position of the first pixel point to acquire an offset position corresponding to the first pixel point;
determine an offset pixel point corresponding to the first pixel point according to the offset position corresponding to the first pixel point;
perform a blur processing on the offset pixel point corresponding to the first pixel point to acquire a blurred color value corresponding to the first pixel point; and
assign the blurred color value corresponding to the first pixel point to a color value of the first pixel point to generate a blurred image corresponding to the initial image.

16. The storage medium according to claim 15, wherein the computer-executable instructions causing the one or more processors to perform random offset processing on the pixel position of the first pixel point to acquire an offset position corresponding to the first pixel point further cause the one or more processors to:
generate a first random number and a second random number;
acquire a second coordinate value according to the first random number and a first coordinate value, the first coordinate value being a horizontal-axis coordinate value of the pixel position of the first pixel point;
acquire a fourth coordinate value according to the second random number and a third coordinate value, the third coordinate value being a vertical-axis coordinate value of the pixel position of the first pixel point; and
acquire the offset position corresponding to the first pixel point according to the second coordinate value and the fourth coordinate value.

17. The storage medium according to claim 16, wherein,
the computer-executable instructions causing the one or more processors to acquire a second coordinate value according to the first random number and a first coordinate value further cause the one or more processors to: calculate a product of the first random number and a first preset coefficient to acquire a first calculated value, and sum the first coordinate value and the first calculated value to acquire the second coordinate value; and
the computer-executable instructions causing the one or more processors to acquiring a fourth coordinate value according to the second random number and a third coordinate value further cause the one or more processors to: calculate a product of the second random number and a second preset coefficient to acquire a second calculated value, and sum the third coordinate value and the second calculated value to acquire the fourth coordinate value.

18. The storage medium according to claim 15, wherein the computer-executable instructions causing the one or more processors to perform a blur processing on the offset pixel point corresponding to the first pixel point to acquire a blurred color value corresponding to the first pixel point further cause the one or more processors to:
determine a plurality of sampled points corresponding to the offset pixel point corresponding to the first pixel point based on a preset sampling step size and a preset neighborhood range; and
acquire the blurred color value corresponding to the first pixel point according to a color value of each sampled point and a weight coefficient of each sampled point.

19. The storage medium according to claim 18, wherein the computer-executable instructions causing the one or more processors to acquire the blurred color value corresponding to the first pixel point according to a color value of each sampled point and a weight coefficient of each sampled point further cause the one or more processors to:
perform weighted summation on the color values of all sampled points according to weight coefficients of all sampled points to acquire a total color value;
sum the weight coefficients of all sampled points to acquire a total weight coefficient; and
calculate a ratio of the total color value to the total weight coefficient to acquire the blurred color value corresponding to the first pixel point.

20. The storage medium according to claim 18, wherein the computer-executable instructions causing the one or more processors to determine a plurality of sampled points corresponding to the offset pixel point corresponding to the first pixel point based on a preset sampling step size and a preset neighborhood range further cause the one or more processors to:
determine whether a first pixel region is located within the initial image, the first pixel region being a region within a preset neighborhood range of the offset pixel point corresponding to the first pixel point; and
in response to at least one pixel point in the first pixel region being located outside the initial image, assign a value to the at least one pixel point according to the initial image, and sample within the first pixel region based on the preset sampling step size to determine the plurality of sampled points.
